(19) United States
(12) Patent Application Publication
(10) Pub. No.: US 2008/0037924 A1
(43) Pub. Date: Feb. 14, 2008

(54) Pin Cage, Particularly for Larger Radial or Axial Roller Bearings

(75) Inventor: Rudolf Zeidlhack, Werneck (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/577,218

(22) PCT Filed: Oct. 8, 2005
(86) PCT No.: PCT/DE05/01804

§ 371 Date: Apr. 13, 2007

(30) Foreign Application Priority Data
Oct. 14, 2004 (DE) 10 2004 049 968.3

(51) Int. Cl. F16C 33/52

(52) U.S. Cl. 384/574

(57) ABSTRACT

The invention relates to a pin cage for large radial or axial roller bearings. The pin cage has axle pins between spacing bolts. The axle pins being retained in axial bores in the annular disks. The roller bearing elements are rotatably mounted on the axle pins. The pin cage is a structural unit which is preassembled separately from the roller bearing elements and has free minimum distance between all roller bearing elements at the level of the graduated circle of the axial bores for the axle pins, the diameter of the graduated circle of the axial bores for the spacing bolts being smaller or larger than the diameter of the graduated circle of the axial bores for the axle pins. The axle pins for the roller bearing elements are cylinder pins which are inserted into the axial bores of the preassembled structural unit from the outside.

### FIELD OF THE INVENTION

The invention relates to a pin cage according to the features which form the preamble of patent claim 1, and it can be realized advantageously, in particular, on all larger roller bearing design types having roller bodies, for example on radial or axial cylindrical roller bearings, on radial or axial self-aligning roller bearings, on radial or axial tapered roller bearings, on radial or axial spherical roller bearings, or else on angular contact roller bearings.

### BACKGROUND OF THE INVENTION

It is generally known to a person skilled in the art of roller bearing technology that the guidance of the roller bodies is frequently realized by bolt cages in large roller bearing design types having roller bodies, as roller bearings of this type have a very high loadability on account of a bolt cage making it possible to accommodate a maximum number of roller bodies. As the roller bodies for a roller bearing of this type, however, have to be drilled through axially for their guidance on the bolts of the bolt cage, it was necessary, in order to maintain their loadability, to manufacture them from case hardened steel which is relatively expensive. In order to reduce the manufacturing costs for roller bearings of this type, it has therefore also been known for a long time to guide the roller bodies of the roller bearing in what are known as pin cages, as the roller bodies for cages of this type no longer have to be drilled through axially and can therefore be manufactured from roller bearing steels which are far more cost-effective.

A pin cage of this type which forms the generic type is already known, for example, from DE 26 08 308 C2. This pin cage comprises two annular disks which lie axially opposite one another and are connected to one another with a plurality of spacer bolts which are welded into two axial holes in the annular disks, the axial holes of the spacer bolts being arranged on a pitch circle which corresponds approximately to the mean diameter of the annular disks. Moreover, the pin cage has axle journals which are held in further axial holes, which lie axially opposite one another, in the annular disks, are arranged in the circumferential direction between the spacer bolts and on the same pitch circle as the latter, and on which the roller bodies are mounted rotatably which are configured with axial blind holes on their end sides. The axle journals of the pin cage have a concentric collar of increased diameter and a smaller axial cone on the roller side, with the result that the roller bodies are guided both radially and axially in the pin cage via the blind holes in their end sides which are configured with the same diameter as the collar on the axle journals.

However, it is a disadvantage in a pin cage which is configured in this way that the axial holes for the spacer bolts and for the axle journals of the pin cage are arranged on the same pitch circle of the annular disks, as fewer roller bodies can therefore be arranged in the cage as a result of the spacer bolts which are arranged between the roller bodies, and the bearing has a lower loadability as a result. Although this disadvantage is to be minimized in the known pin cage by only four spacer bolts connecting the two annular disks of the pin cage to one another, only four spacer bolts, however, would not ensure the required stability of the pin cage in larger roller bearing design types. This required stability can only be achieved reliably in larger roller bearing design types if in each case one spacer bolt is arranged between two respective roller bodies, with the result that correspondingly fewer roller bodies can be arranged in the cage in a pin cage of the known design as a result of the required large number of these spacer bolts.

A further disadvantage of the known pin cage, moreover, is that the axle journals for the roller bodies, as a result of their configuration on the roller side with a concentric collar of increased diameter, have to be introduced before the assembly of the cage or before the connection of the annular disks to one another by the spacer bolts in the annular disks, as it is otherwise no longer possible to introduce the roller bodies into the pin cage. The assembly of the known pin cage therefore has to take place in such a way that, after the axle journals are introduced into their axial holes in the annular disks, the roller bodies are plugged onto the axle journals of an annular disk and the spacer bolts are pressed into the axial holes of the same annular disk, subsequently the other annular disk is plugged with the axle journals onto the roller bodies and the spacer bolts and finally the spacer bolts are welded to the annular disks. However, cage assembly of this type is not only very complicated, but above all has the disadvantage that the necessary welding work has to be performed on the finally assembled cage and disadvantageous warping on the cage occurs as a result of the thermal influences, which warping possibly results in alignment errors during the guidance of the roller bodies in the cage.

### OBJECT OF THE INVENTION

Proceeding from the described disadvantages of the known prior art, the invention is therefore based on the object of designing a pin cage, particularly for larger radial or axial roller bearings, with which, despite the use of a plurality of spacer bolts between the annular disks, the arrangement of a maximum number of roller bodies in the cage and simple cage assembly without welding work on the finally assembled cage are ensured.

### DESCRIPTION OF THE INVENTION

According to the invention, this object is achieved in a pin cage according to the preamble of claim 1 in such a way that this pin cage is configured as a structural unit which has a uniform free minimum spacing between all roller bodies at the level of the pitch circle of the axial holes for the axle journals, can be preassembled separately from the roller bodies, and in which the diameter of the pitch circle of the axial holes for the spacer bolts is smaller and/or greater than the diameter of the pitch circle of the axial holes for the axle journals, and in which the axle journals for the roller bodies are configured as cylindrical pins which can be introduced into the preassembled structural unit from the outside into their axial holes.

In one preferred embodiment of the pin cage which is configured according to the invention, the diameter of the pitch circle of the axial holes for the axle journals is preferably configured to be greater than the mean diameter of the annular disks, while, at the same time, the diameter of the pitch circle of the axial holes for the spacer bolts is configured to be smaller than the mean diameter of the annular disks. This ensures that the spacer bolts are no longer arranged between the individual roller bodies, but below the roller bodies, and that therefore one spacer bolt can still be arranged between two respective roller bodies which are arranged at a minimum spacing with respect to one another. As an alternative with the same effect, however, it is also possible to arrange the axial holes for the spacer bolts on a greater pitch circle than the axial holes for the axle journals, in the opposite manner to that described above, with the result that the spacer bolts are likewise no longer arranged between the individual roller bodies, but above the roller bodies. It is likewise also conceivable to arrange the axial holes for the axle journals directly on the mean diameter of the annular disks and to arrange the axial holes for the spacer bolts both on a greater and on a smaller pitch circle than this mean diameter, with the result that the spacer bolts are arranged alternately above and below the roller bodies.

Furthermore, it is proposed as an appropriate development of the pin cage which is configured according to the invention that the spacer bolts are preferably formed by cylindrical steel pegs which are of slightly longer configuration than the roller bodies and have pins of reduced diameter in each case at their ends. The spacer bolts can be pressed and welded in their axial holes in the annular disks by way of these pins, the shoulders on the spacer bolts which are produced by the pins defining the spacing of the annular disks with respect to one another. As an alternative, however, there is also the possibility of providing one of the pins on the spacer bolts with an external thread and screwing them into the corresponding axial holes which are configured with an internal thread in one of the annular disks, with the result that the spacer bolts only have to be welded or fastened in some other way in the axial holes of the other annular disk.

Moreover, it is a further feature of the pin cage which is configured according to the invention that the axle journals, which are configured as cylindrical pins, for the roller bodies have at least partially an external thread on their outer circumferential face and are fixed in the axial holes by being screwed in from the outside into said axial holes in the annular disks which are likewise configured at least partially with an internal thread on their inner circumferential faces. It is particularly advantageous here not to configure the internal thread continuously in the axial holes in the annular disks, as this therefore results in reliable fixing of the axle journals against a stop within the axial holes and at the same time prevents excessive screwing in of the axle journals into the annular disks with the consequence of jamming of the roller bodies. It is likewise advantageous to configure the axle journals on their end side which faces away from the roller in a suitable manner for applying a suitable assembly tool, in order to make it easier to screw the axle journals into the axial holes in the annular disks.

In an alternative embodiment of the pin cage which is configured according to the invention, however, it is also possible to introduce the axle journals, which are configured as cylindrical pins, for the roller bodies into their axial holes in the annular disks from the outside by a press fit and to fix them in the latter in each case by a securing pin which is introduced into a radial hole which traverses the respective axial hole and the respective axle journal. Fastening of this type of the axle journals in the annular disks has proved particularly inexpensive, as threads which are to be machined on the axle journals or in the axial holes in the annular disks are not necessary and also configuration of that end side of the axle journals which faces away from the roller in a suitable mariner for applying an assembly tool can be omitted.

Finally, it is also a last feature of the pin cage which is configured according to the invention that the axial blind holes on the end sides of the roller bodies are lined with an additional plastic sleeve which is configured with a collar which bears against the end sides of the roller bodies. A plastic sleeve of this type has proved particularly advantageous for accurate radial guidance of the roller bodies, while the axial guidance of the roller bodies preferably takes place by axial rims on one of the raceways of the bearing. At the same time, a plastic sleeve of this type improves the friction conditions between the roller bodies and the axle journals of the pin cage and additionally avoids, as a result of its collar, contacts between the end faces of the roller bodies and the annular disks of the pin cage, with the result that overall a lower bearing friction moment is achieved. Instead of plastic sleeves, however, it is also conceivable for smaller roller bearings, for example roller sleeves or the like, to be placed onto the axle journals of the pin cage, by way of which the friction conditions can be improved still further between the roller bodies and the axle journals.

The pin cage which is configured according to the invention therefore has the advantage over the pin cages which are known from the prior art that it has an optimum circumferential utilization as a result of the arrangement of the axial holes for the axle journals on a different pitch circle in its annular disks which is spaced apart radially from the pitch circle of the axial holes for the spacer bolts, by way of which optimum circumferential utilization, on the one hand, between all the roller bodies one spacer bolt can be arranged and the cage can therefore be of extremely stable configuration, but on the other hand none of the spacer bolts is arranged directly between the roller bodies any longer and the bearing can therefore be equipped with a maximum number of roller bodies made from a cost-effective roller bearing steel. Moreover, the pin cage according to the invention is distinguished by its ability to be assembled simply and by favorable friction conditions between it and the roller bodies, and above all by the fact that the necessary welding work during the connection of the annular disks to the spacer bolts can be carried out not on the finally assembled cage but separately from the assembly of the roller bodies, as the axle journals for the roller bodies can be introduced from the outside into their axial holes in the annular disks after the welding of the annular disks. Moreover, further savings in the manufacturing costs of a pin cage of this type can be achieved if the annular disks and the spacer bolts of the pin cage are manufactured from a single-piece cast blank made from cast steel or brass.

### BRIEF DESCRIPTION OF THE DRAWINGS

One preferred embodiment of the pin cage which is configured according to the invention will be explained in greater detail in the following text with reference to the appended drawings, in which:

FIG. 1 shows a cross section through a radial cylindrical roller bearing having a pin cage which is configured according to the invention, in accordance with the line A-A in FIG. 2;

FIG. 2 shows an enlarged illustration of a detail of a side view of a radial cylindrical roller bearing having a pin cage which is configured according to the invention;

FIG. 3 shows a cross section through a pin cage which is configured according to the invention, having a first embodiment of the fastening of the axle journals in the annular disks; and

FIG. 4 shows a cross section through a pin cage which is configured according to the invention, having a second embodiment of the fastening of the axle journals in the annular disks.

### DETAILED DESCRIPTION OF THE DRAWINGS

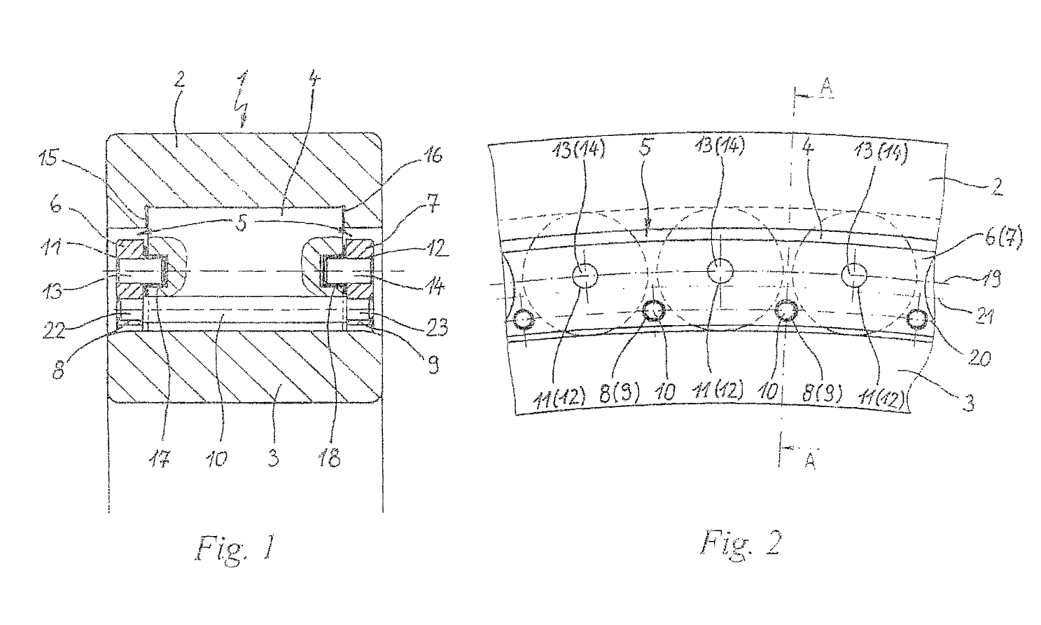

A radial bearing which is configured as a cylindrical roller bearing 1 and has a larger diameter is clearly apparent from FIG. 1, which radial bearing comprises substantially two concentric raceways 2, 3 as well as a number of roller bodies 4 which are arranged between the raceways 2, 3. The roller bodies 4 are kept at uniform spacings from one another in the circumferential direction by a pin cage 5 which is formed by two annular disks 6, 7 which lie axially opposite one another and are connected to one another with a plurality of spacer bolts 10 which are fastened into two axial holes 8, 9 in the annular disks 6, 7. Furthermore, as can be seen from FIGS. 1 and 2, the pin cage 5 has, in the circumferential direction between the spacer bolts 10, axle journals 13, 14 which are held in further axial holes 11, 12, which lie axially opposite one another, in the annular disks 6, 7, on which axle journals 13, 14 the roller bodies 4 are mounted rotatably which are configured with axial blind holes 17, 18 on their end sides 15, 16.

Moreover, when viewed in conjunction with FIG. 1, the illustration according to FIG. 2 makes it clear that the pin cage 5 is configured according to the invention as a structural unit which has a uniform free minimum spacing between all roller bodies 4 at the level of the pitch circle 19 of the axial holes 11, 12 for the axle journals 13, 14, can be preassembled separately from the roller bodies 4, and in which the diameter of the pitch circle 20 of the axial holes 8, 9 for the spacer bolts 10 differs from the diameter of the pitch circle 19 of the axial holes 11, 12 for the axle journals 13, 14, and in which the axle journals 13, 14 for the roller bodies 4 are configured as cylindrical pins which can be introduced into the preassembled structural unit from the outside into their axial holes 11, 12. It can be seen clearly here that the diameter of the pitch circle 19 of the axial holes 11, 12 for the axle journals 13, 14 is configured to be greater than the mean diameter 21 of the annular disks 6, 7, while the diameter of the pitch circle 20 of the axial holes 8, 9 for the spacer bolts 10 is smaller than the mean diameter 21 of the annular disks 6, 7. As a result, the spacer bolts 10 are no longer arranged directly between the individual roller bodies 4, but radially below the roller bodies 4, with the result that one spacer bolt 10 can still be arranged between two respective roller bodies 4 which are arranged at a minimum spacing with respect to one another, and the cylindrical roller bearing 1 can therefore be equipped with a maximum number of roller bodies 4 made from a cost-effective roller bearing steel.

Here, in one concrete embodiment, as can be gathered likewise from FIGS. 1 and 2, the spacer bolts 10 are formed by cylindrical steel pegs which are of slightly longer configuration than the roller bodies 4 and have pins 22, 23 of reduced diameter at their ends, by way of which pins 22, 23 the spacer bolts 10 can be pressed and welded in their axial holes 8, 9 in the annular disks 6, 7.

Furthermore, it is clearly apparent from FIG. 3 that the axle journals 13, 14 for the roller bodies 4 have, in a first embodiment, at least partially an external thread 24, 25 on their outer circumferential face and are fixed in their axial holes 11, 12 by being screwed in from the outside into said axial holes 11, 12 in the annular disks 6, 7 which are likewise configured at least partially with an internal thread 26, 27 on their inner circumferential faces.

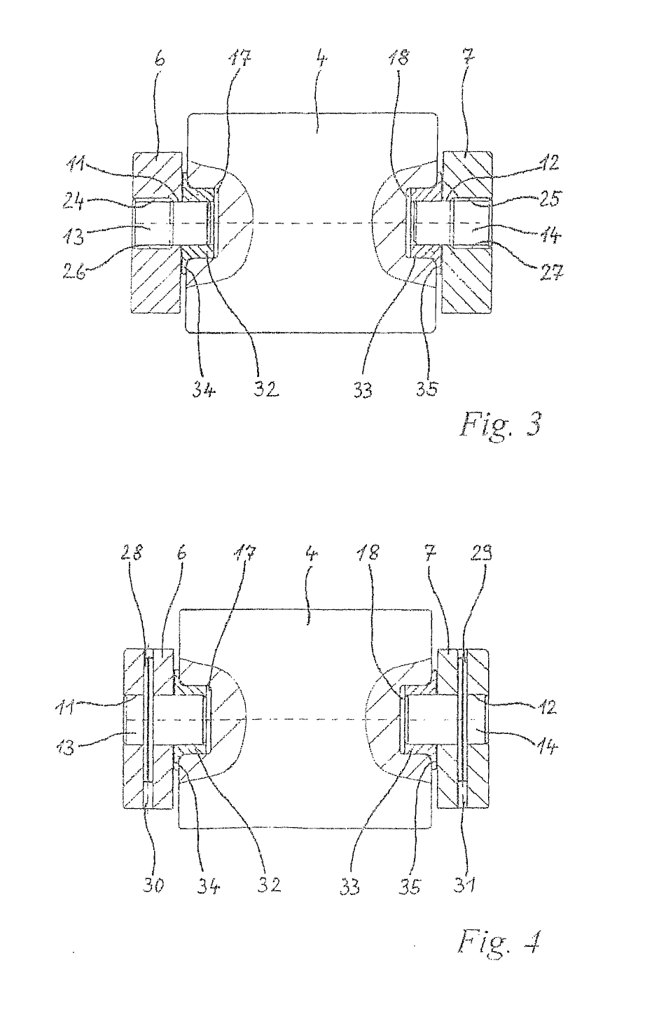

In contrast, FIG. 4 shows that the axle journals 13, 14 for the roller bodies 4 can also be introduced into their axial holes 11, 12 in the annular disks 6, 7 from the outside by a press fit, as an alternative second embodiment, and are then fixed in the latter in each case by a securing pin 28, 29 which is introduced into a radial hole 30, 31 which traverses the respective axial hole 11, 12 and the respective axle journal 13, 14.

It is possible both with the embodiment according to FIG. 3 and with the embodiment according to FIG. 4 to carry out the necessary welding work connecting the annular disks 6, 7 to the spacer bolts 10 not on the finally assembled pin cage 5, but separately from the assembly of the roller bodies 4, as the axle journals 13, 14 for the roller bodies can be introduced from the outside into their axial holes in the annular disks 6, 7 after welding of the annular disks 6, 7.

Moreover, there is also provision in the embodiments which are shown in FIGS. 3 and 4 for the axial blind holes 17, 18 on the end sides 15, 16 of the roller bodies 4 to be lined in each case with an additional plastic sleeve 32, 33 which is configured with a collar 34, 35 which bears against the end sides 15, 16 of the roller bodies 4. These plastic sleeves 32, 33 serve, on the one hand, to reduce the friction between the pin cage 5 and the roller bodies 4 and on the other hand to guide the roller bodies 4 accurately in a radial manner, while the axial guidance of the roller bodies 4 is carried out by the axial rims on the outer raceway 2 of the cylindrical roller bearing 1, which axial rims can be seen in FIG. 1 and are not denoted in greater detail.

### LIST OF DESIGNATIONS

1 Cylindrical roller bearing
2 Raceway
3 Raceway
4 Roller body
5 Pin cage
6 Annular disk
7 Annular disk
8 Axial holes for 10
9 Axial holes for 10
10 Spacer bolts
11 Axial holes for 13
12 Axial holes for 14
13 Axle journal
14 Axle journal
15 End sides
16 End sides
17 Blind holes
18 Blind holes
19 Pitch circle of 11, 12
20 Pitch circle of 8, 9
21 Mean diameter of 6, 7
22 Pin on 10
23 Pin on 10
24 External thread on 22
25 External thread on 23
26 Internal thread in 11
27 Internal thread in 12
28 Securing pin
29 Securing pin
30 Radial hole
31 Radial hole
32 Plastic sleeve
33 Plastic sleeve
34 Collar on 32
35 Collar on 33

1. A pin cage, which comprises two concentric raceways and a number of roller bodies which are arranged between the raceways and are kept at uniform spacings with respect to one another in the circumferential direction by the pin cage, the pin cage being formed by two annular disks which lie opposite one another and are connected to one another with a plurality of spacer bolts which are fastened into two axial holes in the annular disks, and has axle journals which are held in axial holes, which lie axially opposite one another, in the annular disks in the circumferential direction between the spacer bolts, on which axle journals the roller bodies are mounted rotatably which are configured with axial blind holes on their end sides, wherein the pin cage is configured as a structural unit which has a uniform free minimum spacing between all roller bodies at the level of the pitch circle of the axial holes for the axle journals, can be preassembled separately from the roller bodies, in which the diameter of the pitch circle of the axial holes for the spacer bolts is smaller or greater than the diameter of the pitch circle of the axial holes for the axle journals, and in which the axle journals for the roller bodies are configured as cylindrical pins which can be introduced into the preassembled structural unit from the outside into their axial holes.

2. The pin cage as claimed in claim 1, wherein the diameter of the pitch circle of the axial holes for the axle journals is preferably configured to be greater than, and the diameter of the pitch circle of the axial holes for the spacer bolts is preferably configured to be smaller than the mean diameter of the annular disks.

3. The pin cage as claimed in claim 2, wherein the spacer bolts are formed by cylindrical steel pegs which are of slightly longer configuration than the roller bodies and have pins of reduced diameter at their ends, by way of which pins the spacer bolts can be pressed and welded in their axial holes in the annular disks.

4. The pin cage as claimed in claim 3, wherein the axle journals for the roller bodies have at least partially an external thread on their outer circumferential face and are fixed in their axial holes by being screwed in from the outside into said axial holes in the annular disks which are likewise configured at least partially with an internal thread on their inner circumferential faces.

5. The pin cage as claimed in claim 3, wherein that the axle journals for the roller bodies are introduced into their axial holes in the annular disks from the outside by a press fit and are fixed in the latter by a securing pin which is introduced into a radial hole which traverses the respective axial hole and the respective axle journal.

6. The pin cage as claimed in claim 4 wherein the axial blind holes on the end sides of the roller bodies are lined with a plastic sleeve which is configured with a collar which bears against the end sides of the roller bodies and is provided in order to reduce the friction between the pin cage and the roller bodies.
